(19) United States
(12) Patent Application Publication
(10) Pub. No.: US 2026/0225369 A1
(43) Pub. Date: Aug. 6, 2026

(54) LIQUID SUPPLYING APPARATUS

(71) Applicant: BROTHER KOGYO KABUSHIKI KAISHA, Nagoya (JP)

(72) Inventor: Masashi IWAMOTO, Nagoya (JP)

(73) Assignee: BROTHER KOGYO KABUSHIKI KAISHA, Nagoya (JP)

(21) Appl. No.: 19/630,581

(22) Filed: Mar. 27, 2026

Related U.S. Application Data
(63) Continuation of application No. PCT/JP2025/001765, filed on Jan. 21, 2025.

(30) Foreign Application Priority Data
Jan. 31, 2024 (JP) 2024-013277

(51) Int. Cl. B41J 2/175; B41J 29/13

(52) U.S. Cl. CPC B41J 2/17523; B41J 2/17553; B41J 29/13

(57) ABSTRACT

An ink supply unit includes a unit casing, and a cartridge case capable of accommodating an ink container. The unit casing has a panel having an insertion port, and a case housing part which houses the cartridge case inserted from the insertion port. The case housing part has a bottom surface having an inclination which becomes lower in an insertion direction of the cartridge case, and the inclination is set so that in a case where the cartridge case housed in the case housing part is drawn along the bottom surface outward with respect to the insertion port, the upper end of the cartridge case does not exceed the height of the upper end of the unit casing.

### REFERENCE TO RELATED APPLICATIONS

This application is a Continuation Application of International Application No. PCT/JP2025/001765 filed on Jan. 21, 2025 that claims the conventional priority of Japanese patent Application No. 2024-013277 filed on Jan. 31, 2024. The entire content of Japanese patent Application No. 2024-013277 and the entire content of International Application No. PCT/JP2025/001765 are incorporated herein by reference.

### BACKGROUND ART

A known image recording apparatus is capable of holding a liquid cartridge in a cartridge holding part in two different postures. This image recording apparatus is configured such that the liquid cartridge is attachable and detachable with respect to the cartridge holding part by inserting the liquid cartridge into or drawing the liquid cartridge from the cartridge holding part in a horizontal direction.

### SUMMARY

### Technical Problem

The image recording apparatus described above is configured such that the liquid cartridge is inserted into or drawn from the cartridge holding part in the horizontal direction. However, the location where the image recording apparatus is placed is often at a position lower than the user's point of view. In a case where the user inserts or draws the liquid cartridge, the user needs to bend down to lower the point of view and, for example, insert the liquid cartridge into the image recording apparatus while checking the position of the cartridge holding part. Therefore, an operation of attaching the liquid cartridge cannot be performed easily. For this reason, the user wishes, in some cases, to insert or draw the liquid cartridge along an inclination which becomes lower in an insertion direction of the liquid cartridge.

In a case where the image recording apparatus constructed in this way is placed at a location where the space above and below the image recording apparatus are small and where the liquid cartridge is drawn, the liquid cartridge might interfere with an upper wall which constructs the space. Therefore, the space in which the image recording apparatus can be placed is limited.

An object of the present application is to provide a technique by which the limitation on the space in which a liquid supplying apparatus is placed can be minimized as much as possible, even in a case where the liquid supplying apparatus is configured so that a cartridge case which accommodates a liquid container can be inserted into a casing along the inclination which becomes lower in the insertion direction.

### Solution to Problem

In order to achieve the above-described object, a liquid supplying apparatus of the present application includes:
a casing configured to be connected to a recording head configured to eject liquid; and
a cartridge case configured to accommodate a liquid container configured to contain the liquid to be supplied to the recording head,
wherein the casing has a panel having an insertion port into which the cartridge case is inserted, and a case housing part configured to house the cartridge case inserted from the insertion port,
the case housing part has a bottom surface having an inclination becoming lower in an insertion direction in which the cartridge case is inserted, and
the inclination is set so that an upper end of the cartridge case does not exceed a height of an upper end of the casing, in a case where the cartridge case housed in the case housing part is drawn outward with respect to the insertion port along the bottom surface from a position at which a lower surface of the cartridge case faces the bottom surface of the case housing part to a position at which the lower surface of the cartridge case drawn outward with respect to the insertion port does not face the bottom surface of the case housing part.

### Effect of the Invention

According to the present application, the inclination of the bottom surface of the case housing part is set so that the upper end of the cartridge case does not exceed the height of the upper end of the casing in the case where the cartridge case housed in the case housing part is drawn along the bottom surface outward with respect to the insertion port. Accordingly, even in a case where the liquid supplying apparatus is configured so that the cartridge case can be inserted into the casing along the inclination which becomes lower in the insertion direction, the cartridge case can be easily inserted into and drawn from the casing, and the restriction on the space in which the liquid supplying apparatus is placed can be minimized as much as possible.

### BRIEF DESCRIPTION OF DRAWINGS

FIG. 1A and FIG. 1B are perspective views of the external appearance of an ink supply unit according to an embodiment of the present application, depicting a state that the cartridge case is housed (FIG. 1A) and a state that the cartridge case is drawn (FIG. 1B).

FIG. 2A and FIG. 2B are, respectively, a left side view (FIG. 2A) and a front view (FIG. 2B) of the ink supply unit in FIG. 1A and FIG. 1B.

FIG. 3 is a right side view depicting a state that the cover part is detached from the ink supply unit in FIG. 1A and FIG. 1B.

FIG. 4 is a front view of the ink supply unit of FIG. 1A and FIG. 1B seen from an insertion direction of the cartridge case.

FIG. 5 is a six-sided view of the cartridge case which constructs the ink supply unit of FIG. 1A and FIG. 1B.

### DESCRIPTION

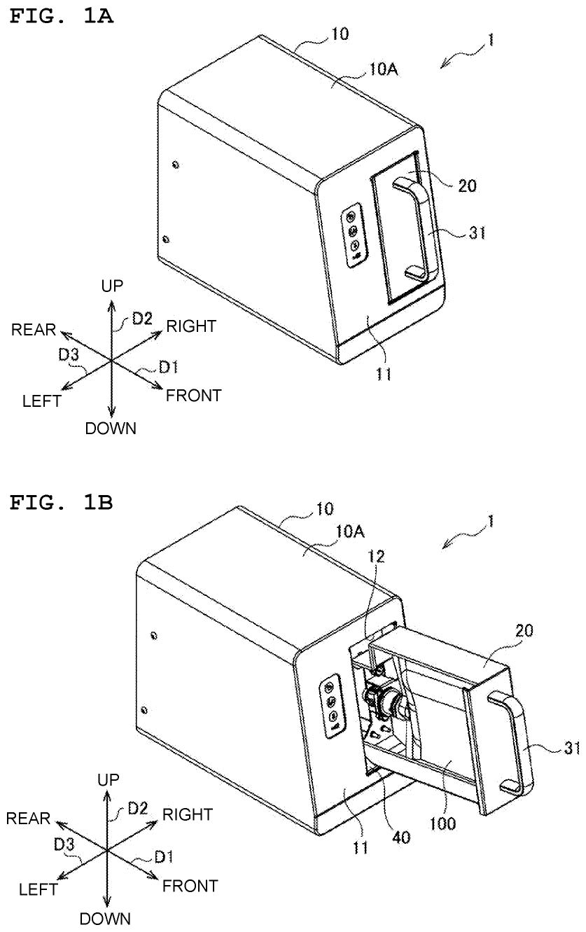

In the following, an embodiment of the present application will be described in detail based on the drawings. In the drawings used in the following description, a part of the basic configuration is omitted in some cases, and the dimensional ratio, etc., of the respective parts depicted in the drawings is not necessarily precise. In FIG. 1A to FIG. 4, a front-rear direction D1, an up-down direction D2, and a left-right direction D3 are as depicted in the respective drawings.

FIGS. 1A and 1B depict the external appearance of an ink supply unit 1 according to the embodiment of the presented application. The ink supply unit 1 is configured to be connectable to a recording head (not depicted in the drawings), which ejects an ink to perform recording (printing) on a recording medium, via, for example, a cable (not depicted in the drawings), and is an apparatus which supplies the ink to the recording head. The ink is an example of “liquid” in the presented application.

As depicted in FIGS. 1A and 1B, the ink supply unit 1 includes a unit casing 10 and a case housing part 40 capable of housing a cartridge case 20 inside the unit casing 10. The cartridge case 20 is configured to accommodate an ink container 100 which contains the ink, and is configured to be detachably housed inside the case housing part 40. FIG. 1A depicts a state that the cartridge case 20 has been completely housed inside the unit casing 10, i.e., inside the case housing part 40, and FIG. 1B depicts a state that the cartridge case 20 is drawn from the unit casing 10.

The unit casing 10 has a panel 11 in the front surface thereof. Further, an insertion port 12 via which the cartridge case 20 is insertable into the case housing part 40 is formed in the panel 11 at a right portion thereof. An operator can insert the cartridge case 20 into or detach (draw) the cartridge case 20 from the case housing part 40 through the insertion port 12, by holding a grip part 31 disposed in the cartridge case 20. The insertion port 12 is formed in the panel 11 at the right portion thereof to thereby allow a right-handed operator to easily attach and detach (draw) the cartridge case 20.

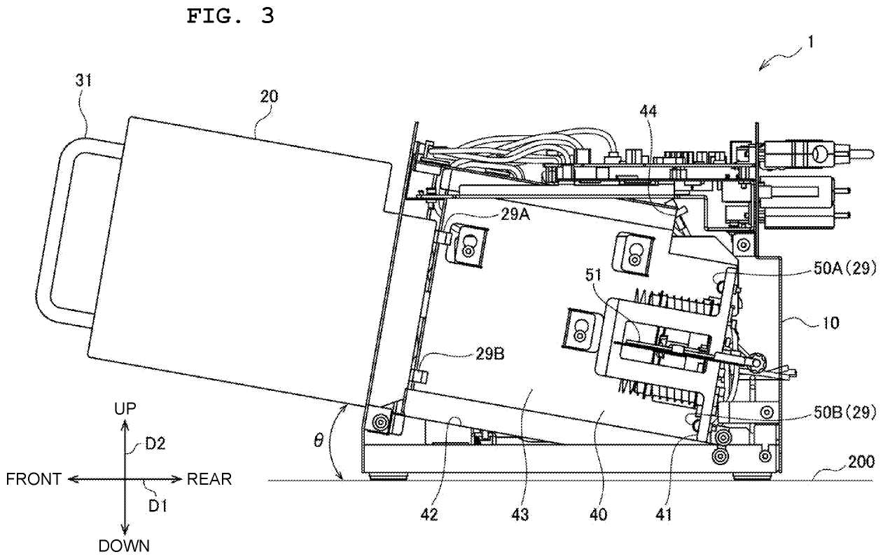

FIG. 3 depicts a state that a cover part 10A (see FIGS. 1A and 1B) is detached from the unit casing 10. As depicted in FIG. 3, the case housing part 40 is configured so that the cartridge case 20 can be inserted, with a predetermined inclination, into the unit casing from the front to the rear of the unit casing 10. Specifically, the predetermined inclination is an inclination becoming lower in an insertion direction in which the cartridge case 20 is inserted into the case housing part 40. In other words, in a case where the cartridge case 20 is being inserted into the case housing part 40, the inclination becomes lower as the cartridge case 20 approaches further a rear end 41 of the case housing part 40. In order to realize this inclination, the case housing part 40 is configured to have a bottom surface 42 including this inclination. The case housing part 40 is configured so that the cartridge case 20 can be inserted by the inclination which becomes lower in the insertion direction in a case where the cartridge case 20 is inserted into the case housing part 40, due to the following two reasons.

The first reason is that a location where the ink supply unit 1 is placed is lower than the user's point of view, in many cases. Therefore, the inclination is provided with such an intention that in a case where the user inserts and draws the cartridge case 20, the user can easily check the position of the insertion port 12 to the case housing part 40, without having to bend down.

The second reason is due to the size of the ink container 100 used in the ink supply unit 1. In the present embodiment, the ink container 100 containing a large amount of the ink, for example, in a range of 300 ml to 1000 ml, is used so that printing by the recording head can be performed continuously for a long period of time. That is, in a case where the ink container 100 filled with the ink is accommodated in the cartridge case 20, the cartridge case 20 becomes heavy because the weight of the ink container 100 is added to the self-weight of the cartridge case 20. The more the amount of ink which can be accommodated in the ink container 100 increases, the greater the weight of the entire cartridge case 20 becomes. In a case where a heavy cartridge case 20 is (being) housed in the unit casing 10, for example, in the horizontal direction, the weight of the cartridge case 20 makes the insertion operation difficult. In contrast to this, in a case where the case housing part 40 is configured so that the cartridge case 20 can be inserted by the inclination which becomes lower in the insertion direction in the case the cartridge case 20 is being inserted into the case housing part 40, the operator only needs to bring the rear end of the cartridge case 20, i.e., the leading end in the insertion direction, to the insertion port 12 of the panel 11, and the subsequent insertion operation of the cartridge case 20 can be completed with a light force, also owing to the addition of the weight of the entire cartridge case 20.

However, in a case where the case housing part 40 is configured so that the cartridge case 20 can be inserted into the unit casing 10 by the inclination which becomes lower in the insertion direction and where the cartridge case 20 is drawn from the unit casing 10, the cartridge case 20 might interfere with an object placed around the unit casing 10, in some cases. Therefore, in the ink supply unit 1 of the present embodiment, the angle of inclination is set so that in a case where the cartridge case 20 is drawn outward with respect to the insertion port 12 of the unit casing 10, the upper end of the cartridge case 20 does not exceed the height of the upper end of the unit casing 10.

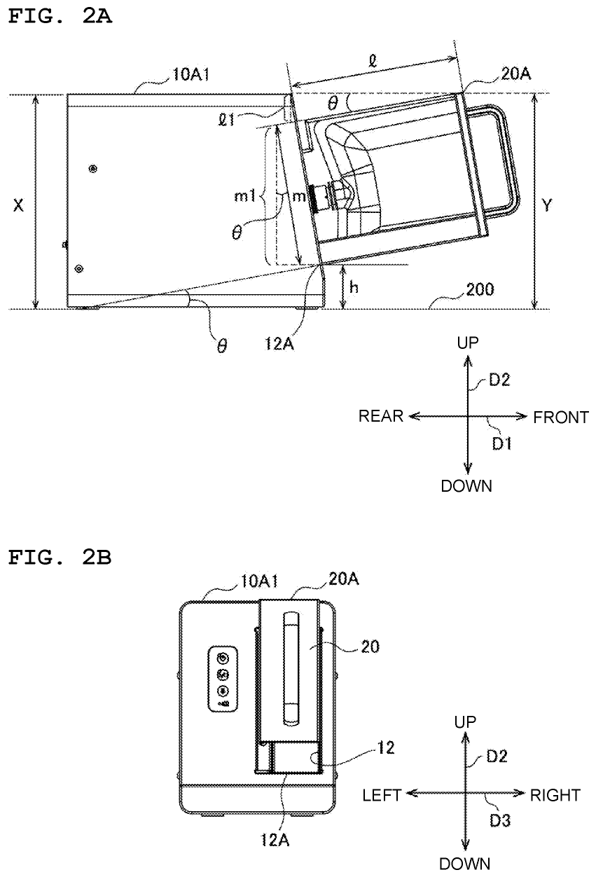

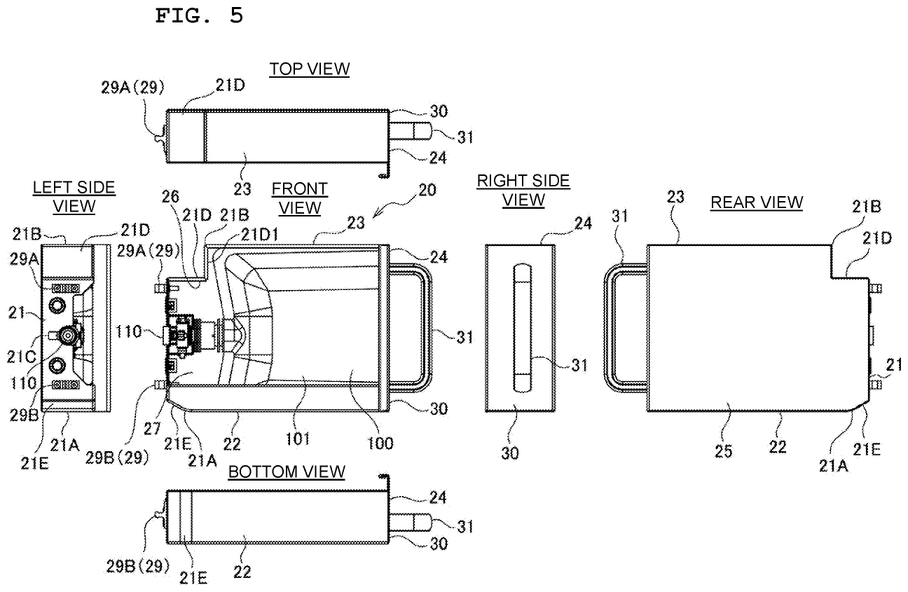

FIGS. 2A and 2B depict a state that the cartridge case 20 is maximally drawn from the unit casing 10. FIG. 2A is a left side view, and FIG. 2B is a front view. As depicted in FIGS. 2A and 2B, in the present embodiment, in a case where the cartridge case 20 is maximally drawn from the unit casing 10 and even where the cartridge case 20 is drawn to a position at which a second surface 22 (see FIG. 5) of the cartridge case 20 does not face the bottom surface 42 (see FIG. 3) of the case housing part 40, an upper end 20A of the cartridge case 20 does not exceed the height of an upper end 10A1 of the unit casing 10.

In the following, the condition of the inclination will be described based on FIG. 2A. In FIG. 2A, a height from the placement surface 200 of the ink supply unit 1 to the upper end 10A1 of the unit casing 10 is defined as “X”. A height from the placement surface 200 of the ink supply unit 1 to a lower end 12A of the insertion port 12 is defined as “h”. Further, an inclination angle of the bottom surface 42 (see FIG. 3) of the case housing part 40 with respect to the placement surface 200 of the ink supply unit 1 is defined as “θ”. Furthermore, a length of the insertion direction of the cartridge case 20 (a length corresponding to an extent of operation in the insertion direction of the cartridge case 20, in the present embodiment, a length of the second surface 22) is defined as “l”, and a height of the cartridge case 20 as seen from the insertion direction (a height of a lid surface 30 (see FIG. 5) in the present embodiment) is defined as “m”.

In a case where the height “m” is converted to a height m1 in the perpendicular direction, that is, the up-down direction D2, m1=m cos θ holds. Further, in a case where length “l” is converted to a height “l1” in the perpendicular direction, l1=l sin θ holds. Accordingly, a height Y from the placement surface 200 to the upper end 20A of cartridge case 20 is expressed by the following expression (1):

$$Y = h + m 1 + l 1 = h + m cos θ + l sin θ . \qquad ( 1 )$$

Further, in a case where a condition of the following expression (2) is satisfied, and even where the cartridge case 20 is drawn maximally from the unit casing 10, the upper end 20A of the cartridge case 20 does not exceed the height of the upper end 10A1 of the unit casing 10:

$$X > Y = h + m cos θ + l sin θ . \qquad ( 2 )$$

As described above, the conditional expression (2) includes the four parameters which are “h”, “m”, “l”, and “θ”. Therefore, although the range of angle θ which satisfies the conditional expression (2) is determined according to the design of the unit casing 10, a specific example of the range of the angle θ is 5 degrees or more and 15 degrees or less.

Next, the configuration of the cartridge case 20 will be described with reference to FIG. 5. FIG. 5 is a sixth-sided view of the cartridge case 20 in which the ink container 100 is accommodated. As depicted in FIG. 5, the cartridge case 20 has first to fifth surfaces 21 to 25 and an opening 26; the cartridge case 20 constructs an accommodating chamber 27, which accommodates the ink container 100, with the first to fifth surfaces 21 to 26 and the opening 26.

The first surface 21 is a surface which becomes a side surface forward in the insertion direction of the cartridge case 20 (the rear side in the front-rear direction D1 in a state that the cartridge case 20 is attached to the ink supply unit 1). The second surface 22 is a surface which is connected to a lower end 21A located in a lower part of the first surface 21, and faces the bottom surface 42 of the case housing part 40 in a case where the cartridge case 20 is housed in the case housing part 40 of the unit casing 10, and is a surface which constructs the lower surface of the cartridge case 20. The third surface 23 is a surface which is connected to an upper end 21B located in an upper part of the first surface 21, and is a surface which constructs the upper surface of the cartridge case 20. The fourth surface 24 is a surface which is connected to the second surface 22 and the third surface 23, and is a side surface rearward in the insertion direction of the cartridge case 20 (the front side in the front-rear direction D1 in the state that the cartridge case 20 is attached to the ink supply unit 1). The fifth surface 25 is a surface which is connected to the first surface 21, the second surface 22, the third surface 23, and the fourth surface 24 and which becomes a side surface located to the right as seen from the insertion direction of the cartridge case 20. The opening 26 is located to the left as seen from the insertion direction of the cartridge case 20 and is open while facing the surface of the fifth surface 25.

The ink container 100 has a bag-shaped pouch 101 which is configured to contain the ink, and a spout 110 which is configured to cause the ink in the pouch 101 to flow outside the pouch 101. Further, an ink supply port 21C is formed in the first surface 21 of the cartridge case 20; the ink supply port 21C is configured to engage with the spout 110 and thereby supply the ink in the pouch 101 to the recording head. Furthermore, male parts 29A and 29B of a catch 29 are attached to the first surface 21C, at locations above and below the ink supply port 21C, respectively, with the ink supply port 21C interposing therebetween. In a case where the cartridge case 20 is housed in the case housing part 40, the male parts 29A and 29B of the catch 29 engage, respectively, with female parts 50A and 50B (see FIG. 3) of the catch 29 attached to the rear end 41 of the case housing part 40.

The cartridge case 20 further has a lid surface 30. The lid surface 30 is disposed in the fourth surface 24, for example, by being adhered to the fourth surface 24. The lid surface 30 is configured to close the insertion port 12 formed in the panel 11 in a case where the cartridge case 20 is housed in the case housing part 40. Note that the fourth surface 24 may also serve as the lid surface 30. The grip part 31 is disposed in the lid surface 30. The grip part 31 is a member which serves as a handle in a case where the cartridge case 20 is attached to and detached (drawn) from the case housing part 40. The grip part 31 is exposed outward from the unit casing 10 in a case where the cartridge case 20 is housed in the case housing part 40.

The cartridge case 20 further has a recessed stepped part 21D. The stepped part 21D is formed on the first surface 21 so that the stepped part 21D faces frontward in the insertion direction of the cartridge case 20, with the upper end 21B of the first surface 21 as a starting point. The stepped part 21D is formed so that in a case where the ink container 100 is housed in the cartridge case 20, an inner wall 21D1, of the first surface 21, constructing the stepped part 21D functions to support a portion of the pouch 101. In a case where the cartridge case 20 is housed in the case housing part 40, the ink container 100 also inclines so as to be lower in the insertion direction of the cartridge case 20, and thus a load is applied, by the weight of the pouch 101, to the spout 110 engaged with the ink supply port 21C. In this situation, since the portion of the pouch 101 is supported by the stepped part 21D (the inner wall 21D1 of the first surface 21 constructing the stepped part 21D), the load applied to the spout 110 due to the weight of the pouch 101 is reduced. In addition, the up-down direction of the cartridge case 20 can be visually recognized easily, owing to the presence of the stepped part 21D, and thus the cartridge case 20 can be prevented from being inserted upside down in a case where the cartridge case 20 is being housed in the case housing part 40. Further, a protruding stepped part 44 is formed in the upper part of the case housing part 40. The stepped part 40 protrudes and faces the stepped part 21D in a case where the cartridge case 20 is housed. In a case where the cartridge case 20 is inserted correctly in the up-down direction D2, the stepped part 44 escapes to the stepped part 21D, and the cartridge case 20 is housed in the case housing part 40 surely up to the rear. However, in a case where the cartridge case 20 is inserted upside down, namely, incorrectly in the up-down direction, a lower part of the first surface 21 interferes with the stepped part 44, and thus the cartridge case 20 cannot be housed in the case housing part 40 surely up to the rear. In this situation, a hollow needle 51, which will be described later, is not inserted into a receiving hole (not depicted in the drawings) in the spout 110. Therefore, the cartridge case 20 can be mechanically prevented from being erroneously attached upside down.

The cartridge case 20 further has an inclined surface 21E at a location which is the lower part of the first surface 21 and at a portion, of the second surface 22, located forward in the insertion direction. Owing to the inclined surface 21E included therein, the first surface 21 is smaller in the up-down direction with respect to the insertion port 12, and thus the cartridge case 20 can be easily inserted into the insertion port 12. The inclined surface 21E is also disposed so that, in a case where the cartridge case 20 is inserted from the insertion port 12 into the case housing part 40, the inclined surface 21E first comes into contact with the bottom surface 42 so as to guide the insertion angle. This makes the cartridge case 20 to be easily positioned in the up-down direction. Further, also in a case where the cartridge case 20 is to be completely drawn to the outside of the insertion port 12, the position of the cartridge case 20 is lowered by the height of the inclination of the inclined surface 21E, and thus the cartridge case 20 can be drawn such that the upper end of the cartridge case 20 does not exceed the height of the upper end of the unit casing 10.

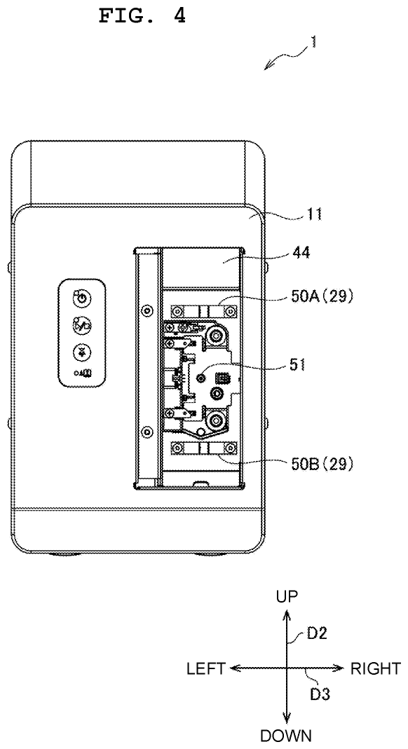

Next, the configuration inside of the unit casing 10 of the ink supply unit 1 will be briefly described with reference to FIGS. 3 and 4. FIG. 4 is a view of the ink supply unit 1 as seen from the insertion direction of the cartridge case 20, depicting a state that the cartridge case 20 is drawn out of the case housing part 40.

The case housing part 40 has a wall part 43 in a left part thereof. The wall part 43 closes the opening 26 of the cartridge case 20 in a case where the cartridge case 20 is housed in the case housing part 40. Therefore, the wall part 43 is disposed at a position adjacent to the opening 26 in a case where the cartridge case 20 is housed in the case housing part 40. The wall part 43 is disposed to prevent the inside of the cartridge case 20 from being irradiated with the light from the opening 26, for the following reason. That is, in a case where the ink container 100 containing an UV ink, which is ultraviolet-curable ink, is used, the ink container 100 is preferably not irradiated with the light as much as possible. Further, even in a case where an ink other than the UV ink is contained in the ink container 100 and where the wall part 43 covers the opening 26 so as to close the opening 26, the wall part 43 usefully prevents the ink from leaking from the inside of the cartridge case 20 to the outside in a case where the ink leaks from the ink container 100.

Further, the female parts 50A and 50B of the catch 29 are attached to the rear end 41 of the case housing part 40, at positions corresponding, respectively, to the male parts 29A and 29B of the catch 29 in the case where the cartridge case 20 is housed in the case housing part 40. In the case where the cartridge case 20 is housed in the case housing part 40, the male parts 29A and 29B of the catch 29 engage, respectively, with the female parts 50A and 50B of the catch 29 attached to the rear end 41 of the case housing part 40. In the catch 29, the male parts 29A and 29B are engaged, respectively, with the female parts 50A and 50B with such a holding force owing to which the cartridge case 20 does not easily come out of the case housing part 40 by the self-weight thereof even in a case where the ink supply unit 1 is in a posture in which the panel 11 faces downward. Accordingly, the cartridge case 20 is stably housed in the case housing part 40 and, consequently, in the ink supplying apparatus 1. Furthermore, even in a case where the ink supply unit 1 is inadvertently tilted in a case where the ink supply unit 1 is being transported or installed and fixed, such an accident that the cartridge case 20 comes out and falls from the ink supply unit 1 can be prevented.

Moreover, a hollow needle 51 penetrates the rear end 41 of the case housing part 40 and protrudes in a direction opposite to the insertion direction of the cartridge case 20. In a case where the cartridge case 20 is housed in the case housing part 40, the hollow needle 51 is inserted into a receiving hole (not depicted in the drawings) in the spout 110 and causes the ink in the ink container 100 to pour out of the ink container 100. Note that the description of an ink spouting method, etc., will be omitted. In the present embodiment, the first surface 21, of the cartridge case 20 to be attached, having the ink supply port 21C provided therein faces downward by the amount corresponding to the inclination, and thus the ink is easily guided in the hollow needle 51 by the effect of gravity. Accordingly, an improvement that the ink in the ink container 100 can be fully used is also obtained.

As described above, the ink supply unit 1 of the present embodiment is characterized in that the ink supply unit 1 includes the unit casing 10 connectable to the recording head capable of ejecting the ink, and the cartridge case 20 capable of accommodating the ink container 100 configured to contain the ink to be supplied to the recording head; that the unit casing 10 includes the panel 11 having the insertion port 12 into which the cartridge case 20 can be inserted, and the case housing part 40 configured to house the cartridge case 20 inserted from the insertion port 12. The case housing part 40 has the bottom surface 42 having the inclination becoming lower in the insertion direction in which the cartridge case 20 is inserted. The inclination is set so that the upper end of the cartridge case 20 does not exceed the height of the upper end of the unit casing 10, in a case where the cartridge case 20 housed in the case housing part 40 is drawn outward with respect to the insertion port 12 along the bottom surface 42 from the position at which the second surface 22 as the lower surface of the cartridge case 20 housed in the case housing part 40 faces the bottom surface 42 of the case housing part 42 to the position at which the second surface 22 drawn outward with respect to the insertion port 12 does not face the bottom surface 42.

As described above, in the ink supply unit 1 of the present embodiment, owing to the inclination of the bottom surface 42 of the case housing part 40, the user can visually recognize the insertion port 12 easily. Further, the inclination is set so that the upper end 20A of the cartridge case 20 does not exceed the height of the upper end 10A1 of the unit casing 10 in the case where the cartridge case 20 housed in the case housing part 40 is drawn outward with respect to the insertion port 12 along the bottom surface 42. Accordingly, even in a case where the ink supply unit 1 is configured so that the cartridge case 20 can be inserted into the unit casing 10 along the inclination which becomes lower in the insertion direction, the restriction on the space in which the ink supply unit 1 is placed can be minimized as much as possible. Therefore, the cartridge case 20 can be easily inserted into and drawn from the unit casing 10.

Further, the ink supply unit 1 is characterized in that, in the case where the height from the placement surface 200 of the ink supply unit 1 to the upper end 10A1 of the unit casing 10 is defined as “X”, the height from the placement surface 200 of the ink supply unit 1 to the lower end 12A of the insertion port 12 is defined as “h”, the inclination angle of the bottom surface 42 of the case housing part 40 with respect to the placement surface 200 of the ink supply unit 1 is defined as “θ”, the length of the insertion direction of the cartridge case 20 is defined as “l”, and the height of the cartridge case 20 as seen from the insertion direction of the cartridge case 20 is defined as “m”, the following expression: X>h+m cos θ+l sin θ is satisfied. In a case where the ink supply unit 1 is designed to satisfy this condition and where the cartridge case 20 housed in the case housing part 40 is drawn outward with respect to the insertion port 12 along the bottom surface 42, the upper end 20A of the cartridge case 20 does not exceed the height of the upper end 10A1 of the unit casing 10. Therefore, even in the case where the ink supply unit 1 is configured so that the cartridge case 20 can be inserted into the unit casing 10 along the inclination which becomes lower in the insertion direction, the restriction on the space in which the ink supply unit 1 is placed can be minimized as much as possible.

Furthermore, the ink supply unit 1 is characterized in that the inclination angle θ of the bottom surface 42 is 5 degrees or more and 15 degrees or less. In a case where the inclination angle θ is set within this range, generally, the user can visually recognize the insertion port 12 easily, and the cartridge case 20 can be easily inserted and drawn even in a case where the cartridge case 20 accommodates a relatively heavy ink container 100. Moreover, in a case where the cartridge case 20 housed in the case housing part 40 is drawn along the bottom surface 42 outward with respect to the insertion port 12, the upper end 20A of the cartridge case 20 does not exceed the height of the upper end 10A1 of the unit casing 10.

Further, the cartridge case 20 is characterized in that the cartridge case 20 includes: the first surface 21 which is the side surface forward in the insertion direction of the cartridge case 20 (the rear side in the front-rear direction D1 in the state that the cartridge case 20 is attached to the ink supply unit 1); the second surface 22 which is connected to the lower end 21A of the first surface 21, and which is the lower surface, of the cartridge 20, facing the bottom surface 42 of the case housing part 40 in the case where the cartridge case 20 is housed in the case housing part 40; the third surface 23 which is connected to the upper end 21B of the first surface 21, and which is the upper surface of the cartridge case 20; the fourth surface 24 which is the side surface rearward in the insertion direction of the cartridge case 20 (the front side in the front-rear direction D1 in the state that the cartridge case 20 is attached to the ink supply unit 1) and which is connected to the second surface 22 and the third surface 23; the fifth surface 25 which is connected to the first surface 21, the second surface 22, the third surface 23, and the fourth surface 24 and which is the side surface located to the right as seen from the insertion direction of the cartridge case 20, the first to fifth surfaces 21 to 25 defining the accommodating chamber 27 configured to accommodate the ink container 100; the opening 26 which is located to the left as seen from the insertion direction of the cartridge case 20 and which is open to face the fifth surface 25; the ink supply port 21C located in the first surface 21 of the cartridge case 20 and configured to engage with the spout 110 disposed in the ink container 100 accommodated in the accommodating chamber 27 and to thereby supply the ink to the recording head; the lid surface 30 disposed in the fourth surface 24 and configured to close the insertion port 12 formed in the panel 11 in the case where the cartridge case 20 is housed in the case housing part 40; and the grip part 31 which is disposed in the lid surface 30 and which is exposed from the unit casing 10 in the case where the cartridge case 20 is housed in the case housing part 40. Note that the lower end 21A of the first surface 21 is an example of the “lower part of the first surface” and the upper end 21B of the first surface 21 is an example of the “upper part of the first surface”.

In a procedure for newly accommodating or replacing an ink container 100 with respect to the cartridge case 20, in a case where the cartridge case 20 is generally oriented correctly by the operator, specifically, the upside and downside of the cartridge case 20 are correctly oriented by the operator so that the opening 26 faces the user, or in a case where the cartridge is placed on a table, etc., so that the third surface 23 faces the user and that the opening 26 faces upward, the grip part 31 is consequently located on the right part of the panel 11. Accordingly, in a case where the right-handed operator picks up the cartridge case 20 after the ink container 100 has been accommodated in the cartridge case 20, the right-handed operator can easily grasp the grip part 31 and the operability is thereby improved.

The cartridge case 20 is further characterized in that the cartridge case 20 has the recessed stepped part 21D on the first surface 21 at the upper part of the first surface 21 and at the portion, of the third surface 23, located forward in the insertion direction. The ink container 100 is further characterized in that the ink container 100 has the bag-shaped pouch 101 configured to accommodate the ink, and the spout 110 configured to cause the ink in the pouch 101 to flow outside the pouch 101; and that the stepped part 21D is configured such that in the case where the ink container 100 is accommodated in the cartridge case 20, the inner wall 21D1, of the first surface 21, constructing the stepped part 21D supports the portion of the pouch 101.

In the case where the cartridge case 20 is housed in the case housing part 40, the ink container 100 also inclines so as to be lower in the insertion direction of the cartridge case 20, and thus the load is applied, by the weight of the pouch 101, to the spout 110 engaged with the ink supply port 21C. In this situation, since the portion of the pouch 101 is supported by the stepped part 21D, the load applied to the spout 110 due to the weight of the pouch 101 is reduced.

The cartridge case 20 is further characterized in that the cartridge case 20 has the male parts 29A and 29B of the catch 29 attached to the first surface 21. Further, the male parts 29A and 29B, of the catch 29, as a plurality of male parts, are disposed in the first surface 21 so that the male parts 29A are disposed above the ink supply port 21C and the male parts 29B are disposed below the ink supply port 21C, with the ink supply port 21C interposing therebetween. In the case where the cartridge case 20 is housed in the case housing part 40, the cartridge case 20 and the case housing part 40 are engaged surely to each other by the male parts 29A and 29B of the catch 29 disposed in the first surface 21 of the cartridge case 20 engaging, respectively, with the female parts 50A and 50B (see FIG. 3) of the catch 29 attached to the rear end 41 of the case housing part 40. Accordingly, such an inconvenience can be avoided that the cartridge case 20 comes off the case housing part 40 in a case where the ink is (being) supplied from the ink supply unit 1 to the recording head, stopping the supply of the ink. Further, such an accident can be avoided that the cartridge case 20 falls off in a case where the ink supply unit 1 is (being) conveyed or placed.

The cartridge case 20 is further characterized in that the cartridge case 20 has the inclined surface 21E at the location which is the lower part of the first surface 21 and at the portion, of the second surface 22, located forward in the insertion direction. The inclined surface 21E serves as the guide causing the cartridge case 20 to be easily positioned in the up-down direction in a case where the cartridge case 20 is (being) inserted into the case housing part 40 from the insertion port 12.

Further, the insertion port 12 of the panel 11 is characterized in that the insertion port 12 is formed in the panel 11 at the position close to the right end of the panel 11 as seen from the insertion direction. Owing to this, the right-handed operator can easily attach and detach (draw) the cartridge case 20.

Further, the case housing part 40 is characterized in that the case housing part 40 has the wall part 43 adjacent to the cartridge case 20 in the direction in which the opening 26 of the cartridge case 20 is open and covering the opening 26 so as to close the opening 26 in the case where the cartridge case 20 is housed in the case housing part 40. In a case where the ink container 100 containing the UV ink, which is the ultraviolet-curable ink, is used, the ink container 100 is preferably not irradiated with the light as much as possible. In a case where the wall part 43 covers the opening 26 so as to close the opening 26, the cartridge case 20 is sealed and thus the ink container 100 is prevented from being irradiated with the light. Even in a case where an ink other than the UV ink is contained in the ink container 100 and where the wall part 43 covers the opening 26 so as to close the opening 26, the wall part 43 usefully prevents the ink from leaking from the inside of the cartridge case 20 to the outside in a case where the ink leaks from the ink container 100.

Note that the present disclosure is not limited to the above-described embodiment, and various modifications are possible without departing from the spirit of the present disclosure.
(1) In the above-described embodiment, although the ink container 1 which contains the ink is used as the liquid container, the kind of ink is not limited to this. Further, the liquid contained in the liquid container may be a liquid other than the ink.
(2) In the above-described embodiment, although the catch is exemplified as the engaging part, the engaging part is not limited to the catch as long as a part or member is configured to engage. Further, the catch may be a ball catch, a magnet catch, etc., and the type of catch is not limited to these examples.
(3) The shapes of the cartridge case 20 and the case housing part 40 are not limited to the shapes described in the above-described embodiment, and may be modified. For example, the first to fifth surfaces 21 to 25 of the cartridge case 20 are not limited to plane surfaces, and may be curved surfaces or convex-concave surfaces, if there is no problem with accommodating the ink container 100 and/or housing or drawing of the cartridge case 20 with respect to the case housing part 40. Similarly, the surfaces constructing the case housing part 40 are not limited to the plane surfaces, and may be curved surfaces or concave-convex surfaces within the range not interfering with the cartridge case 20 which is (being) housed or drawn outward with respect to the case housing part 40.

What is claimed is

1. A liquid supplying apparatus comprising:
a casing configured to be connected to a recording head configured to eject liquid; and
a cartridge case configured to accommodate a liquid container configured to contain the liquid to be supplied to the recording head,
wherein the casing has a panel having an insertion port into which the cartridge case is inserted, and a case housing part configured to house the cartridge case inserted from the insertion port,
the case housing part has a bottom surface having an inclination becoming lower in an insertion direction in which the cartridge case is inserted, and
the inclination is set so that an upper end of the cartridge case does not exceed a height of an upper end of the casing, in a case where the cartridge case housed in the case housing part is drawn outward with respect to the insertion port along the bottom surface from a position at which a lower surface of the cartridge case faces the bottom surface of the case housing part to a position at which the lower surface of the cartridge case drawn outward with respect to the insertion port does not face the bottom surface of the case housing part.

2. The liquid supplying apparatus according to claim 1, wherein in a case where a height from a placement surface of the liquid supplying apparatus to the upper end of the casing is defined as “X”, a height from the placement surface of the liquid supplying apparatus to a lower end of the insertion port is defined as “h”, an inclination angle of the bottom surface of the case housing part with respect to the placement surface of the liquid supplying apparatus is defined as “θ”, a length in the insertion direction of the cartridge case is defined as “l”, and a height of the cartridge case as seen from the insertion direction is defined as “m”, a relational expression: X>h+l sin θ+m cos θ is satisfied.

3. The liquid supplying apparatus according to claim 2, wherein the inclination angle of the bottom surface is 5 degrees or more and 15 degrees or less.

4. The liquid supplying apparatus according to claim 1, wherein the cartridge case has:
a first surface which is a side surface forward in the insertion direction;
a second surface which is connected to a lower part of the first surface and which is a lower surface facing the bottom surface of the case housing part in the case where the cartridge case is housed in the case housing part;
a third surface which is connected to an upper part of the first surface and which is an upper surface of the cartridge case;
a fourth surface which is a side surface rearward in the insertion direction, and connected to the second surface and the third surface;
a fifth surface which is connected to the first surface, the second surface, the third surface and the fourth surface, and which is a right side surface as seen from the insertion direction, the first to fifth surfaces defining an accommodating chamber configured to accommodate the liquid container;
an opening which is located at a left part of the cartridge case as seen from the insertion direction and which is open to face the fifth surface;
a liquid supply port which is located in the first surface and, in the case where the cartridge case is housed in the case housing part, which is configured to engage with a liquid spouting part disposed in the liquid container accommodated in the accommodating chamber to thereby supply the liquid to the recording head;
a lid surface disposed in the fourth surface and configured to close the insertion port in the case where the cartridge case is housed in the case housing part; and
a grip part disposed in the lid surface, the grip part being exposed outward from the casing in the case where the cartridge case is housed in the case housing part.

5. The liquid supplying apparatus according to claim 4, wherein the cartridge case has a recessed stepped part at an upper part of the first surface and at a portion, of the third surface, located forward in the insertion direction.

6. The liquid supplying apparatus according to claim 5, wherein the liquid container has a bag-shaped pouch configured to accommodate the liquid, and a spout configured to cause the liquid inside the pouch to flow outside the pouch, and
an inner wall of the first surface constructing the stepped part supports a portion of the pouch in the case where the liquid container is housed in the cartridge case.

7. The liquid supplying apparatus according to claim 4, wherein the cartridge case has an engaging part in the first surface.

8. The liquid supplying apparatus according to claim 7, wherein a plurality of engaging parts including the engaging part is disposed in the first surface so that the plurality of engaging parts is located above and below the liquid supply port, with the liquid supply port interposing therebetween.

9. The liquid supplying apparatus according to claim 4, wherein the cartridge case has an inclined surface at a lower part of the first surface and at a portion, of the second surface, located forward in the insertion direction.

10. The liquid supplying apparatus according to claim 1, wherein the insertion port of the panel is formed at a position close to a right end of the panel in a case where the panel is seen from the insertion direction.

11. The liquid supplying apparatus according to claim 4, wherein the case housing part has a wall part adjacent to the opening of the cartridge case in a direction in which the opening is open and configured to cover the opening to thereby close the opening in the case where the cartridge case is housed in the case housing part.
